(19) United States
(12) Patent Application Publication
(10) Pub. No.: US 2018/0044146 A1
(43) Pub. Date: Feb. 15, 2018

(54) CANTILEVERED CRANE SYSTEM FOR A FACTORY WORK STATION

(71) Applicants: Terex MHPS GmbH, Dusseldorf (DE); GM Global Technology Operations LLC, Detroit, MI (US)

(72) Inventors: Chad Donahue, Chesterfield, MI (US); Derrick Torrey, White Lake, MI (US)

(21) Appl. No.: 15/673,531

(22) Filed: Aug. 10, 2017

Related U.S. Application Data
(60) Provisional application No. 62/374,189, filed on Aug. 12, 2016.

(51) Int. Cl. B66C 17/00; B66C 13/00; B66C 5/02

(52) U.S. Cl. CPC B66C 17/00; B66C 5/02; B66C 13/00

(57) ABSTRACT

A workstation having a cantilevered crane system that includes one or more cantilevered header assemblies, with each cantilevered header assembly including an upright column and a horizontally oriented header, with the header extending from the column with a free end distal from the column. The headers support a pair of runway rails, with at least one bridge rail movably mounted to the runway rails and supporting a moveable hoist. The cantilevered crane system defines a workstation area bounded by the columns and headers, with the workstation area including an open side adjacent the free ends of the headers.

### CROSS REFERENCE TO RELATED APPLICATION

The present t application claims priority of U.S. provisional application Ser. No. 62/374,189 filed Aug. 12, 2016, which is hereby incorporated herein by reference in its entirety.

### BACKGROUND OF THE INVENTION

The present invention is directed to an overhead cantilevered crane system for use in a facility to provide an open sided work station.

Overhead cranes are used in various types of facilities, such as manufacturing environments, for the movement of inventory, tools, equipment and work in progress components that are being manufactured. Known overhead cranes are configured to include pairs of posts or columns that are secured into a floor surface, with beams affixed to and between the posts and along which a crane trolley system may be moved for assisting the lifting and lowering of items in the area of the overhead crane.

### SUMMARY OF THE INVENTION

The present invention provides a cantilevered crane system for a building to define a work station having an open side opposite columns of the crane system.

According to an aspect of the present invention, a cantilevered crane system comprises a plurality of cantilevered header assemblies, with each cantilevered header assembly including an upright column and a horizontally oriented header, wherein the header extends from the column with a free end distal from the column. Each header supports a pair of runway rails, with at least one bridge rail movably mounted to the runway rails. The cantilevered crane system defines a workstation area bounded by the columns and the headers, with the workstation area including an open side adjacent the free ends of the headers.

The cantilevered crane system provides a work station for a factory or warehouse having multiple open sides to advantageously enable the delivery into and/or removal of parts, products or material into the work station, such as by way of fork lifts or other such means.

These and other objects, advantages, purposes and features of this invention will become apparent upon review of the following specification in conjunction with the drawings.

### BRIEF DESCRIPTION OF THE DRAWINGS

FIG. 1 is an overhead top plan view of a factory work station with a cantilevered crane system in accordance with aspects of the present invention;

FIG. 2 is a side elevation view of the work station and cantilevered crane system of FIG. 1;

FIG. 3 a rear elevation view of the work station and cantilevered crane system of FIG. 1;

FIG. 4 is a perspective view of a cantilevered header assembly of the cantilevered crane system of FIG. 1 shown removed from the crane system;

FIG. 5 is a perspective view of an alternative cantilevered header assembly in accordance with aspects of the present invention;

FIG. 6 is a side elevation view of the cantilevered header assembly of FIG. 5;

FIG. 7 is an exploded perspective view of the cantilevered header assembly of FIG. 5;

FIG. 8A is a top plan view of a support plate assembly for a cantilevered header assembly in accordance with an aspect of the present invention;

FIG. 8B is a side elevation view of the support plate assembly of FIG. 8A shown mounted to a support surface;

FIG. 9 is a perspective view of an alternative cantilevered header assembly for a cantilevered crane system in accordance with another aspect of the present invention;

FIG. 10 is an overhead top plan view of a factory work station employing an alternative cantilevered crane system in accordance with the present invention;

FIG. 11A is an overhead top plan view of another factory work station employing a further alternative cantilevered crane system in accordance with the present invention;

FIG. 11B is a side elevation view of the cantilevered crane system of FIG. 11A; and

FIG. 12 is a side elevation view of another embodiment of a crane system in accordance with the present invention.

### DESCRIPTION OF THE PREFERRED EMBODIMENTS

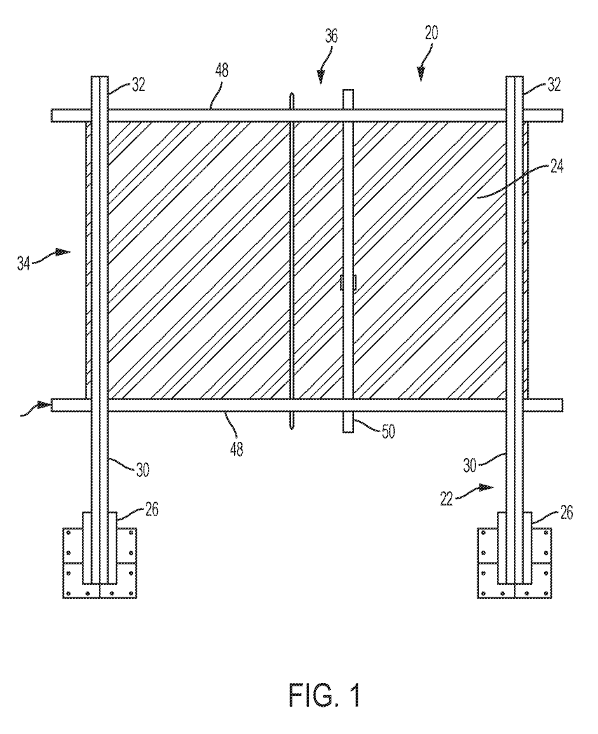

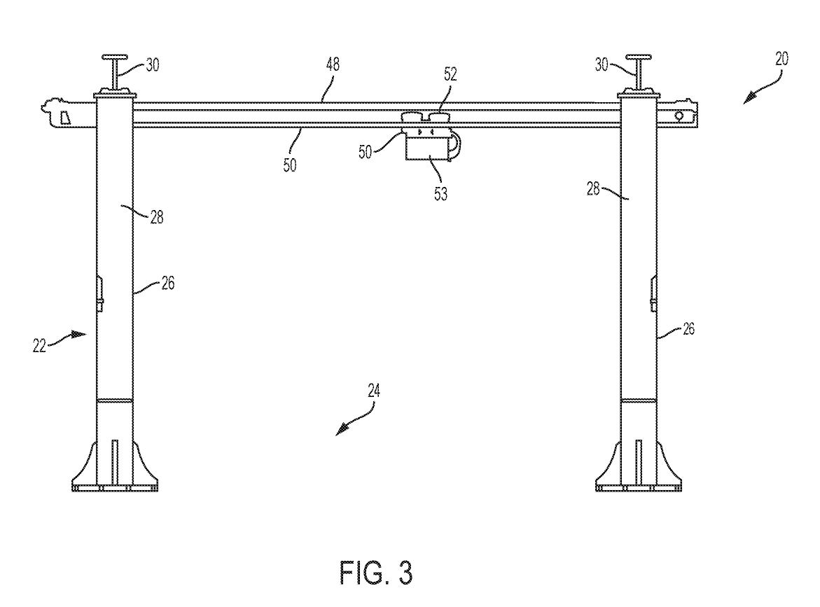

The present invention will now be described with reference to the accompanying figures, wherein the numbered elements in the following written description correspond to like-numbered elements in the figures. A work station 20 is shown in FIGS. 1-3 to include a cantilevered crane system 22. The work station 20 defines an area 24 on a floor surface, such as a cement floor in a building. The crane system 22 includes a pair of cantilevered header assemblies 26 that comprise an upright column or post 28 and a horizontally oriented header 30, where the header 30 is supported in a cantilever fashion to have an end 32 that is freely supported above the floor surface. Work station 20 thus includes three sides 34, 36 and 38 that are free from columns or posts to advantageously enable the delivery into and/or removal of parts, products or material into work station 20, such as by way of a fork lift or other such means.

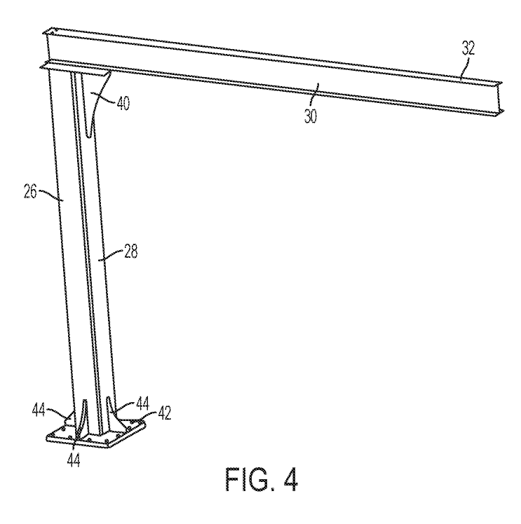

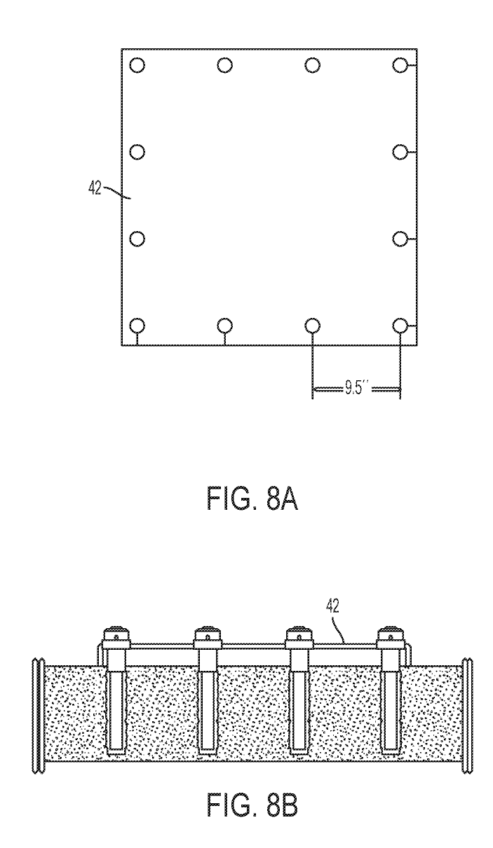

A cantilevered header assembly 26 is additionally shown in FIG. 4 removed from crane system 22. In the illustrated embodiment header 30 comprises a steel I beam and columns 28 comprise square tubes made of steel. A bracket or flange 40 is disposed at the connection of header 30 to column 28, with column 28 being affixed to a mounting plate 42 for securing the assembly 26 to the floor surface, where mounting plate 42 may be secured to the floor via a plurality of fasteners (see FIGS. 8A and 8B). A plurality of brackets or flanges 44 are disposed about the lower connection of column 28 with mounting plate 42.

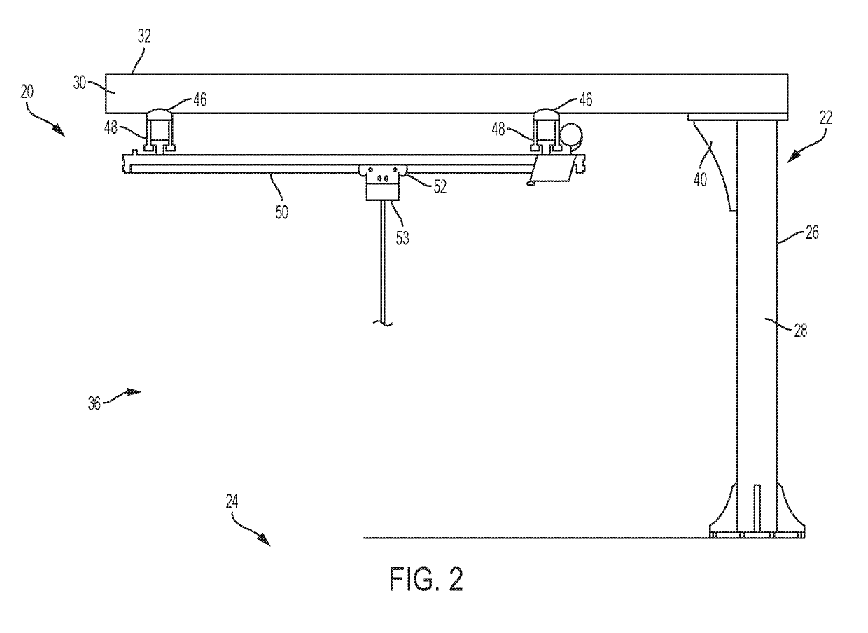

Referring again to FIGS. 1-3, in addition to columns 28 and headers 30, crane system 22 further includes hangar brackets 46 that are secured to headers 30 and are used to support runway rails 48 that span between headers 30 of the two cantilevered header assemblies 26. As understood from FIGS. 1 and 2, crane system 22 includes a pair of rails 48 that are disposed along the length of headers 30, with one positioned nearer to columns 28 and the other rail 48 disposed nearer to the ends 32 of headers 30. Still further, a bridge or bridge rail 50 is movably supported between runway rails 32, with bridge 50 including a moveable hoist that includes a trolley 52 that slides axially along bridge 50 with trolley 52 supporting a hoist 53, such as a chain hoist or air host. It should be appreciated that multiple bridge rails with moveable hoists may be movably supported on runway rails 32, or that a moveable hoist may be supported by more than one bridge rail.

In operation, crane system 22 is thus able to transport or move parts, containers, or the like about area 24 of work station 20 while readily enabling access to work station 20 via sides 34, 36 and 38. In the illustrated embodiment, headers 30 extend from columns approximately 20 feet, and are supported approximately 14 feet above the floor surface.

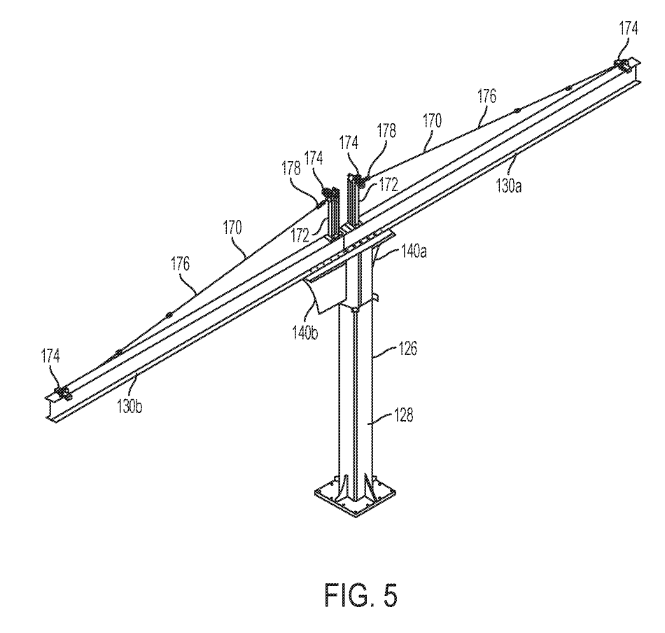

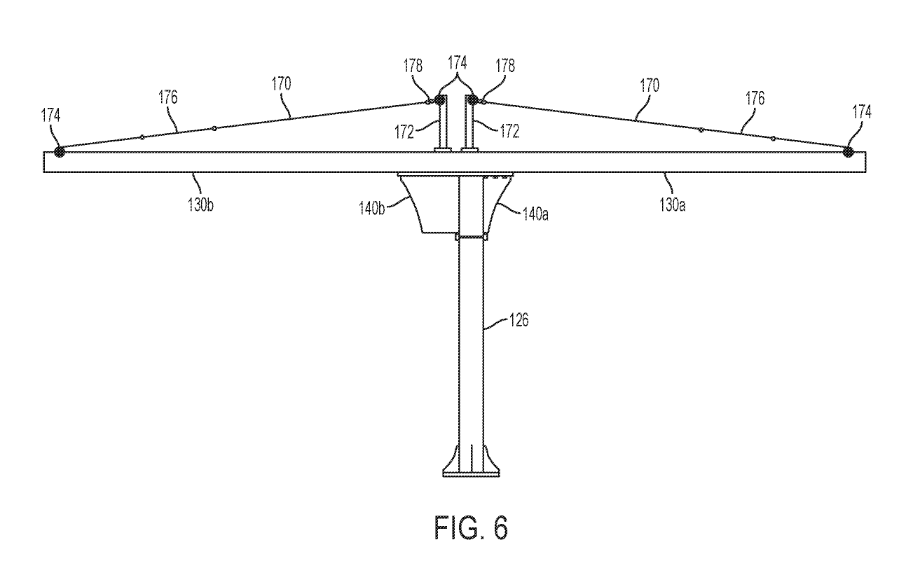

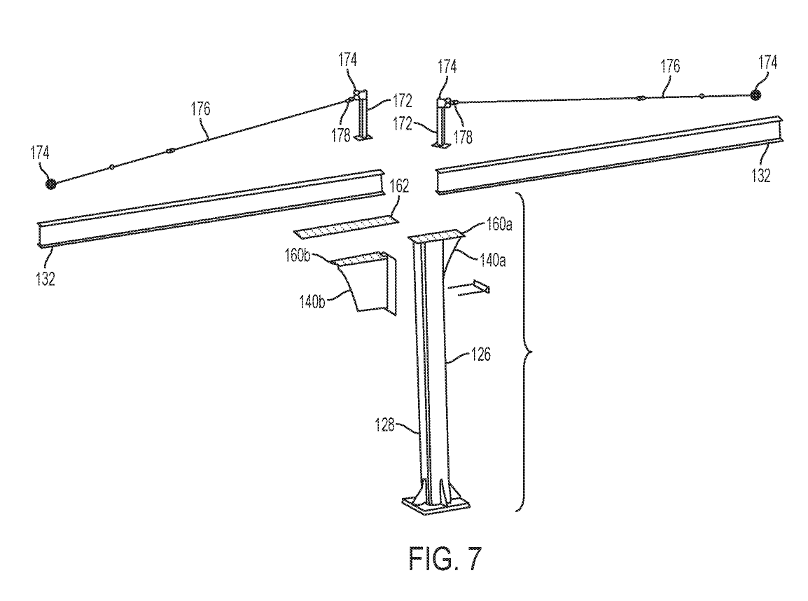

Referring now to FIGS. 5-7, an alternative cantilevered header assembly 126 is illustrated that includes a pair of headers 130a, 130b extending outwardly from column 128 to form a generally T-shaped configuration. Cantilevered header assembly 126 is used to provide crane systems to work stations located on either side of column 128, where such a work station may employ one or more of header assemblies 126 and header assemblies 26.

Cantilevered header assembly 126 is shown to include a first bracket 140a that is used in the connection of header 130a to column 128. A second bracket 140b is included that is used in the connection of header 130b to column 128. As shown, each of brackets 140a and 140b include an upper plate portion 160a, 160b, respectively. An additional mounting plate 162 is provided that spans the upper plate portions 160a, 160b, with fasteners being used to secure the headers 130a, 130b through mounting plate 162 to brackets 140a, 140b.

In the illustrated embodiment each of headers 130a, 130b optionally includes a support or vibration dampening assembly 170, which aids in supporting and inhibiting the effects of harmonic vibrations from movement of bridges or bridge rails along runway rails, and the like. The dampening assemblies 170 include upright or vertically oriented members 172 extending from the upper surface of the headers 130a, 130b. Each assembly further includes a pair of brackets 174, with one mounted to the upright member 172 and the other mounted near the end 132 of each of the headers 130a, 130b. In the illustrated embodiment brackets 174 comprise hangar brackets, such as hangar brackets 46 noted above. A tension support member is disposed between the brackets 174, where in the illustrated embodiment the tensions support member comprises a threaded rod 176. Tensioners are joined with the tension support members, where in the illustrated embodiment the tensioners comprise turnbuckles 178 connected at one of the brackets 174 to control the tension on the threaded rods 176. It should be appreciated that alternative configurations may be employed, including unthreaded rods or cables in place of rods or the like. Although shown in connection with a T-shaped cantilevered header assembly 126, it should also be appreciated that a support or dampening assembly may be used with a system having a single cantilevered header of the format shown in FIG. 4, in which case an upright member is provided with a rod extending therefrom toward the free end of the cantilevered header.

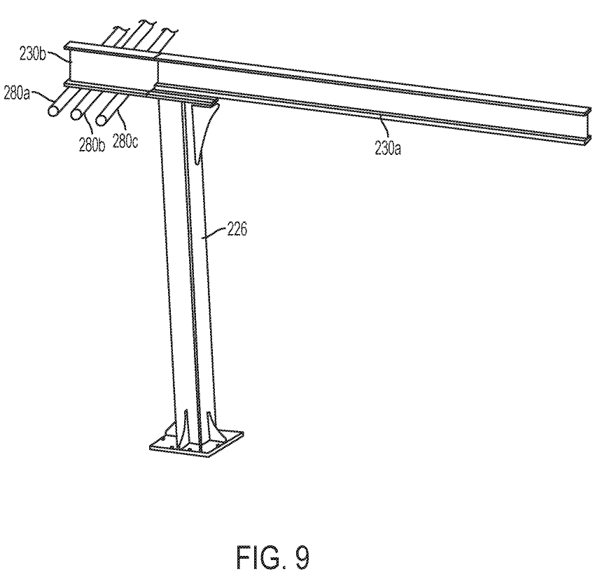

FIG. 9 illustrates another alternative generally T-shaped cantilevered header assembly 226 having a pair of headers 230a, 230b. As shown, header 230b is shorter in length than header 230a. Instead of supporting crane components, header 230b is configured to support plant services components thereon, such as water lines 280a, electrical conduits 280b, compressed air lines 280c, and the like. Header assemblies 226 may thus be used in the formation of a modular work station that is fully supported with utilities for operating equipment within the workstation, as well as be used to support the plant services for supplying to other work stations and/or areas of the building.

Although work station 20 is shown to include a cantilevered crane system 22 having just two cantilevered header assemblies 26, it should be appreciated that alternative work stations may be configured in accordance with the scope of the present invention. For example, more than two header assemblies 26 may be used to extend the length or run of runway rails supported thereon. Still further, multiple work stations may be serviced by systems that include a portion of or all of the header assemblies configured as T-shaped header assemblies. Still further, lamppost column assemblies having shorter headers may be used in connection with header assemblies 26, 126 or 226, where the header of such a lamppost assembly may connect with and support a single runway rail.

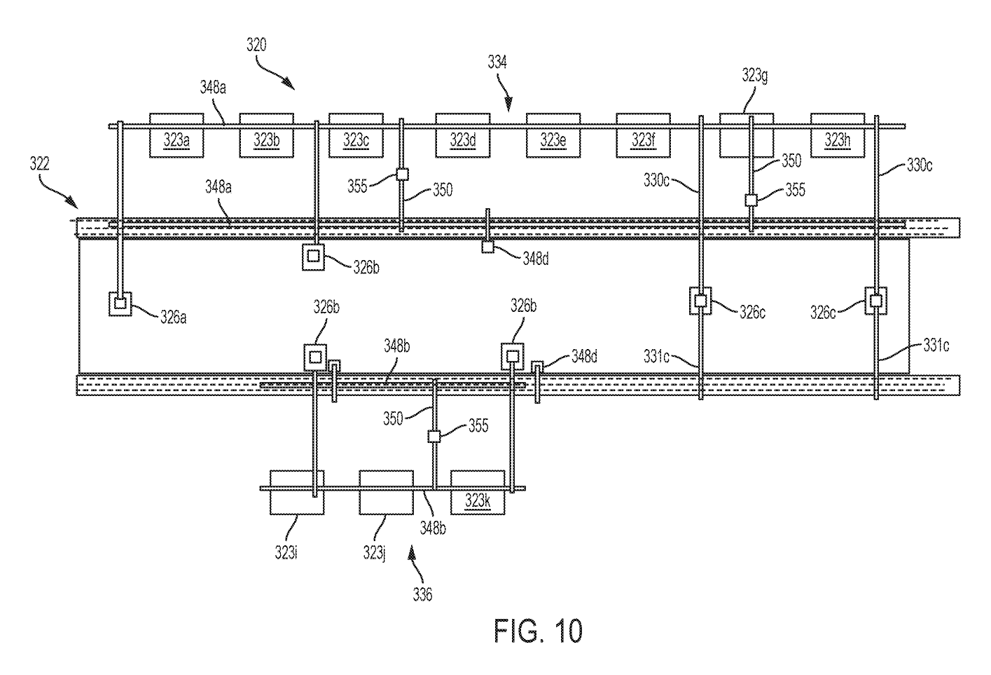

An example of an alternative work station 320 is depicted in FIG. 10 with cantilevered crane system 322, which illustrates the utilization of multiple alternative cantilevered header assemblies together. As shown, system includes cantilevered header assemblies 326a, 326b, 326c and 326d, where assemblies 326a and 326b are of the inverted “L” configuration similar to header assemblies 26 of FIGS. 1 to 3. Header assembly 326c has a “T” configuration similar to header assembly 126 of FIG. 5, and includes a first horizontal header 330c and a second horizontal header 331c. A pair of spaced runway rails 348a are supported by header assembly 326a, a header assembly 326b and the first horizontal headers 330c of the header assemblies 326c. Another pair of spaced runway rails 348b are supported by the other two header assemblies 326b. Header assemblies 326d comprise L-shaped assemblies with short horizontally extending headers for supporting one of the runway rails 348a. Bridge rails 350 are supported between each of the pair of runway rails 348a and 348b, where each bridge rail 350 includes a moveable hoist 355 that slides along the elongate length of the bridge rails 350. As thus configured, work station 320 has elongate sides 334 and 336 that are free of columns or posts, thus facilitating the delivery, storage and/or removal of parts, products or material thereat, such as at the various locations labeled 323a to 323k in FIG. 10.

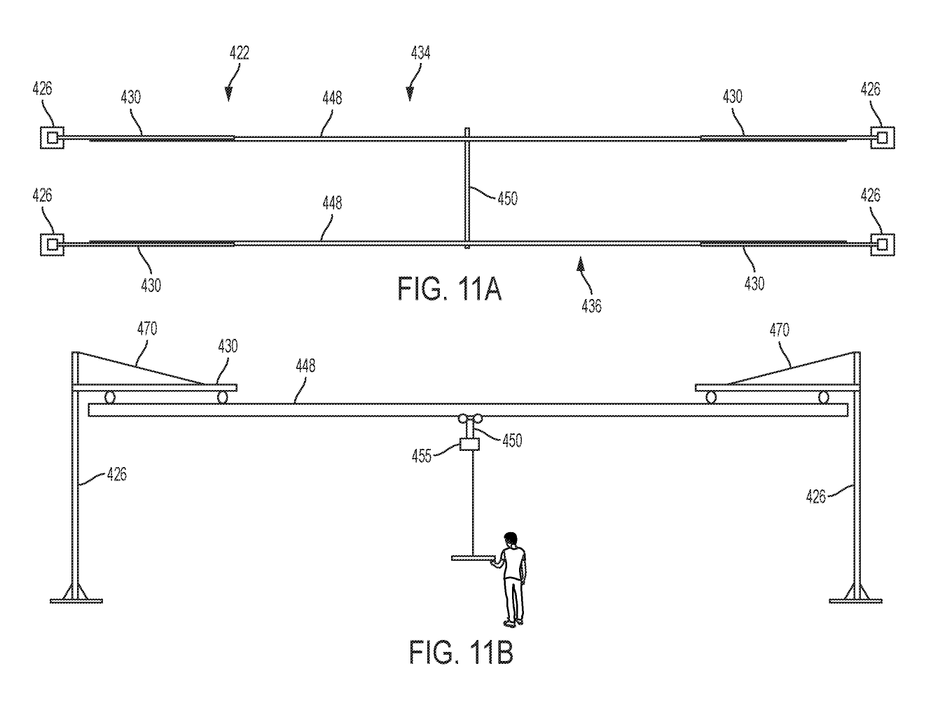

A further alternative work station 420 is depicted in FIGS. 11A and 11B with cantilevered crane system 422. System 422 comprises four cantilevered header assemblies 426 that each include a horizontal header 430. System 422 further includes runway rails 448, with each runway rail 448 extending between a pair of axially aligned headers 430 of a pair of header assemblies 426. A bridge rail 450 is movably supported between the runway rails 448, with a moveable hoist 455 disposed on the bridge rail 450. As understood from FIG. 11B, each header assembly 426 additionally includes a support or vibration dampening assembly 470, where assemblies 470 are configured in like manner to assembly 170 discussed above. Crane system 422 may be employed to provide a larger span on open sides 434, 436 while enabling smaller sized runway rails 448.

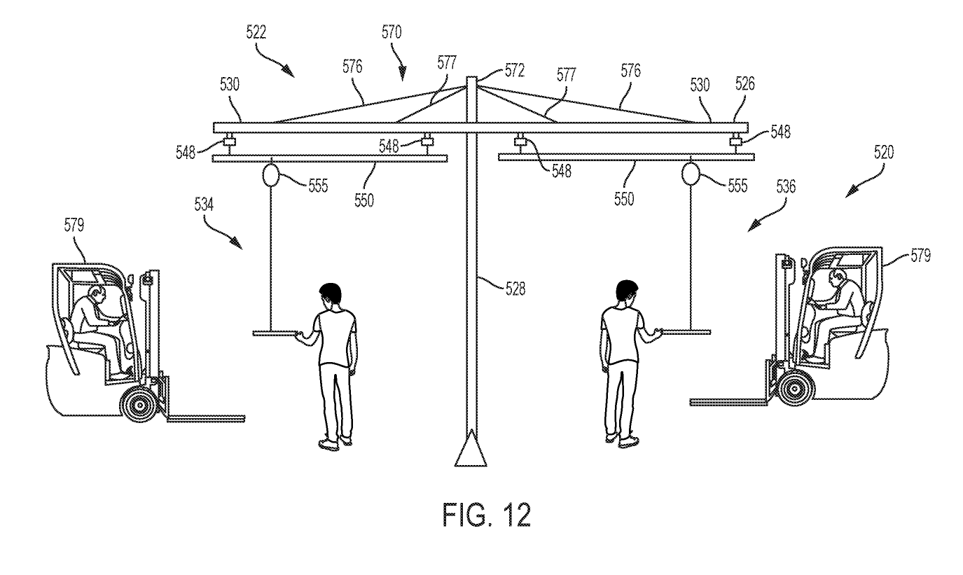

Another work station 520 is depicted in FIG. 12 with cantilevered crane system 522. System 522 comprises two or more cantilevered header assemblies 526 (one shown in FIG. 12) with runway rails 548 supported from headers 530 that extend outwardly from column 528. Bridge rails 550 are in turn supported by the runway rails 548, with movable hoists 555 disposed on the bridge rails 550. System 522 further includes a support or vibration dampening assembly 570, where assembly 570 includes a single vertically oriented upright member 572 extending above headers 530, with rods 576 and 577 extending therefrom. As shown, rods 576 extend outwardly proximate the free end of the headers 530, while rods 577 extend a shorter distance along the headers 530. Thus in the illustrated embodiment, rods 576 extend past an approximate half-way point of the length of the headers 530, while rods 577 extend less than a half-way point of the length of the headers 530. FIG. 12 further depicts the ease of which access to the interior of work station 520 is obtained, such as by way of forklifts entering at open sides 534 and 536, due to the absence of additional columns or posts.

Although the above discussed crane systems are shown and discussed to include at least two cantilevered header assemblies, it should be appreciated that one or more cantilevered header assemblies may be employed with conventional header mounting constructions in a crane system, whereby the cantilevered header assemblies provide openings into a work station, or may be used in environments having limited space that prevent the ability to use a pair of columns to support a header. The cantilevered crane systems of the present invention thus provide work stations having open sides to advantageously enable the delivery into and/or removal of parts, products or material into the work station, such as by way of fork lifts or other such means, including for factories or warehouses or the like.

Further changes and modifications in the specifically described embodiments can be carried out without departing from the principles of the present invention which is intended to be limited only by the scope of the appended claims, as interpreted according to the principles of patent law including the doctrine of equivalents.

1. A workstation having a cantilevered crane system comprising:
a plurality of cantilevered header assemblies, with each said cantilevered header assembly including an upright column and a horizontally oriented header, wherein said header extends from said column with a free end distal from said column;
each said header supporting a pair of runway rails; and
at least one bridge rail movably mounted to said runway rails and supporting a moveable hoist;
said cantilevered crane system defining a workstation area bounded by said columns and said headers, with said workstation area including an open side adjacent said free ends of said headers.

2. The workstation of claim 1, wherein said runway rails are disposed perpendicularly to said headers.

3. The workstation of claim 2, wherein said bridge rail is disposed perpendicularly to said runway rails.

4. The workstation of claim 1, wherein at least one of said cantilevered header assemblies comprises a generally T-shaped assembly having a pair of headers extending outwardly from said column of said at least one of said cantilevered header assemblies.

5. The workstation of claim 4, wherein one of said headers of said generally T-shaped cantilevered header assemblies supports plant service equipment.

6. The workstation of claim 1, further including at least one vibration dampening assembly mounted to a said cantilevered header assembly whereby said cantilevered header assembly comprises a tensioned cantilevered header assembly, wherein said vibration dampening assembly comprises a vertically oriented post extending above said header of said tensioned cantilevered header assembly and an elongate tension member extending angularly relative to said header from said post toward said free end of said header.

7. The workstation of claim 6, wherein said post extends above said header of said tensioned cantilevered header assembly proximate to where said header connects with said upright column of said tensioned cantilevered header assembly.

8. The workstation of claim 7, wherein said tension member is connected to said header of said tensioned cantilevered header assembly proximate said free end of said header.

9. The workstation of claim 6, further including a tensioner connected to said elongate tension member, said tensioner configured to selectively adjust tension applied to said tension member.

10. The workstation of claim 6, wherein said elongate tension member comprises a rod.

11. The workstation of claim 10, wherein said rod comprises a threaded rod.

12. The workstation of claim 11, further including a tensioner connected with said threaded rod, and wherein said tensioner comprises a turnbuckle.

13. A crane system comprising:
at least one cantilevered header assembly, said cantilevered header assembly including an upright column and a horizontally oriented header, wherein said header extends from said column with a free end distal from said column;
each said header supporting a pair of runway rails, wherein said runway rails are disposed perpendicularly to said header; and
at least one bridge rail movably mounted to said runway rails wherein said bridge rail is disposed perpendicularly to said runway rails and supports a trolley mounted hoist.

14. The crane system of claim 13, further including a vibration dampening assembly mounted to said cantilevered header assembly, wherein said vibration dampening assembly comprises a vertically oriented post extending above said header of said cantilevered header assembly and an elongate tension member extending angularly relative to said header from said post toward said free end of said header.

15. The crane system of claim 14, wherein said post extends above said header of said cantilevered header assembly proximate to where said header connects with said upright column of said cantilevered header assembly.

16. The crane system of claim 15, further including a tensioner connected to said elongate tension member, said tensioner configured to selectively adjust tension applied to said tension member.

17. The crane system of claim 16, wherein said elongate tension member comprises a threaded rod, and wherein said tensioner comprises a turnbuckle.

18. The crane system of claim 13, further including a plurality of cantilevered header assemblies.

19. The crane system of claim 13, wherein said at least one cantilevered header assembly includes a pair of headers extending outwardly from said column, with each said header having a free end distal from said column.

20. The crane system of claim 19, wherein said headers are aligned with each other along the elongate axial length of said headers.
